(19) United States
(12) Patent Application Publication
(10) Pub. No.: US 2012/0245808 A1
(43) Pub. Date: Sep. 27, 2012

(54) VEHICLE CONTROL APPARATUS AND VEHICLE CONTROL METHOD

(75) Inventors: Takashi SHIRAKI, Toyota-Shi (JP); Yasuhiro ONO, Toyota-shi (JP); Morito ASANO, Osaka (JP)

(73) Assignee: Toyota Jidosha Kabushiki Kaisha, Toyota-shi (JP)

(21) Appl. No.: 13/426,164

(22) Filed: Mar. 21, 2012

(30) Foreign Application Priority Data
Mar. 22, 2011 (JP) 2011-063200

(51) Int. Cl. G06F 7/00

(52) U.S. Cl. 701/51; 701/70

(57) ABSTRACT

A vehicle control apparatus includes a detection unit that detects whether or not a reverse driving operation to select a reverse driving of a vehicle has been performed, wherein the vehicle backs up the vehicle, and a control unit that executes vehicle speed limiting control of limiting a traveling speed of the vehicle to a speed equal to or lower than a first speed when the vehicle backs up, and prohibits execution of the vehicle speed limiting control when the traveling speed of the vehicle is equal to or higher than a second speed that is higher than the first speed and when the detection unit detects that the reverse driving operation has been performed.

### INCORPORATION BY REFERENCE

The disclosure of Japanese Patent Application No. 2011-063200 filed on Mar. 22, 2011 including the specification, drawings and abstract is incorporated herein by reference in its entirety.

### BACKGROUND OF THE INVENTION

1. Field of the Invention

The invention relates to a vehicle control apparatus and a vehicle control method that limit a traveling speed of a vehicle when the vehicle backs up.

2. Description of Related Art

When a vehicle backs up, a passenger assumes a less natural posture or has a narrower visual field than when the vehicle travels forward. Therefore, the driving operation to back up the vehicle is more difficult than the driving operation to cause the vehicle to travel forward. Thus, it is desirable to facilitate the driving operation of the vehicle by limiting the traveling speed of the vehicle to prevent the traveling speed from becoming too high when the vehicle backs up.

Japanese Patent Application Publication No. 59-155545 (JP-A-59-155545) proposes the execution of vehicle speed limiting control of limiting the traveling speed of the vehicle to a speed equal to or lower than a predetermined speed at the time when a reverse travel (in which the vehicle backs up) has been selected.

In general, it is detected whether the forward travel of the vehicle or the reverse travel of the vehicle has been selected through a driving operation by a passenger, by a sensor or a switch that is fitted to the vehicle, for example, a sensor for detecting an operation mode of a transmission, a switch for detecting an operated position of a shift lever, or the like. Thus, in the case where noise is superimposed on an output signal of such a sensor (or such a switch) or a control apparatus that acquires the output signal of the sensor or the sensor itself malfunctions, it may be erroneously determined that the reverse travel of the vehicle has been selected, although a driving operation of selecting the reverse travel of the vehicle has actually not been performed.

In the apparatus described in JP-A-59-155545, when the erroneous determination as described above is made and the traveling speed is limited through the vehicle speed limiting control while the vehicle travels forward, the traveling speed of the vehicle may unnecessarily fall, or the degree of the fall in the traveling speed may increase to cause a shock to the vehicle when the traveling speed is high. As a result, a deterioration in drivability may be caused.

### SUMMARY OF INVENTION

The invention provides a vehicle control apparatus and a vehicle control method that can restrain a deterioration in drivability in the case where it is erroneously detected that the reverse travel of a vehicle has been selected while the vehicle travels forward.

A first aspect of the invention is a vehicle control apparatus including a detection unit that detects whether or not a reverse driving operation to select a reverse travel of a vehicle has been performed, wherein the vehicle backs up in the reverse traveling, and a control unit that executes vehicle speed limiting control of limiting a traveling speed of the vehicle to a speed equal to or lower than a first speed when the vehicle backs up, and prohibits execution of the vehicle speed limiting control when the traveling speed of the vehicle is equal to or higher than a second speed that is higher than the first speed and the detection unit detects that the reverse driving operation has been performed.

A second aspect of the invention is a vehicle control method including detecting whether or not a reverse driving operation to select a reverse travel of a vehicle has been performed, wherein the vehicle backs up in the reverse travel, executing vehicle speed limiting control of limiting a traveling speed of the vehicle to a speed equal to or lower than a first speed during back-up of the vehicle, and prohibiting execution of the vehicle speed limiting control when the traveling speed of the vehicle is equal to or higher than a second speed that is higher than the first speed and when it is detected that the reverse driving operation has been performed.

According to the first and second aspects of the invention, in an apparatus that executes vehicle speed limiting control of limiting a traveling speed of a vehicle when the vehicle backs up, an unnecessary fall in the traveling speed or the occurrence of a shock can be restrained in the case where it is erroneously detected that the reverse travel of the vehicle has been selected while the vehicle travels forward. As a result, a deterioration in drivability can be restrained.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing an overall configuration of a vehicle to which a vehicle control apparatus according to the first embodiment of the invention is applied;

FIG. 2 is a flowchart showing a processing procedure of an execution prohibition processing according to the first embodiment of the invention;

FIG. 3 is a timing chart showing a first example of a mode of performing the execution prohibition processing;

FIG. 4 is a timing chart showing a second example of the mode of performing the execution prohibition processing;

FIG. 5 is a timing chart showing a third example of the mode of performing the execution prohibition processing;

FIG. 6 is a flowchart showing a processing procedure of an execution prohibition processing according to the second embodiment of the invention; and

FIG. 7 is a timing chart showing a fourth example of a mode of performing the execution prohibition processing.

### DETAILED DESCRIPTION OF EMBODIMENTS

### First Embodiment

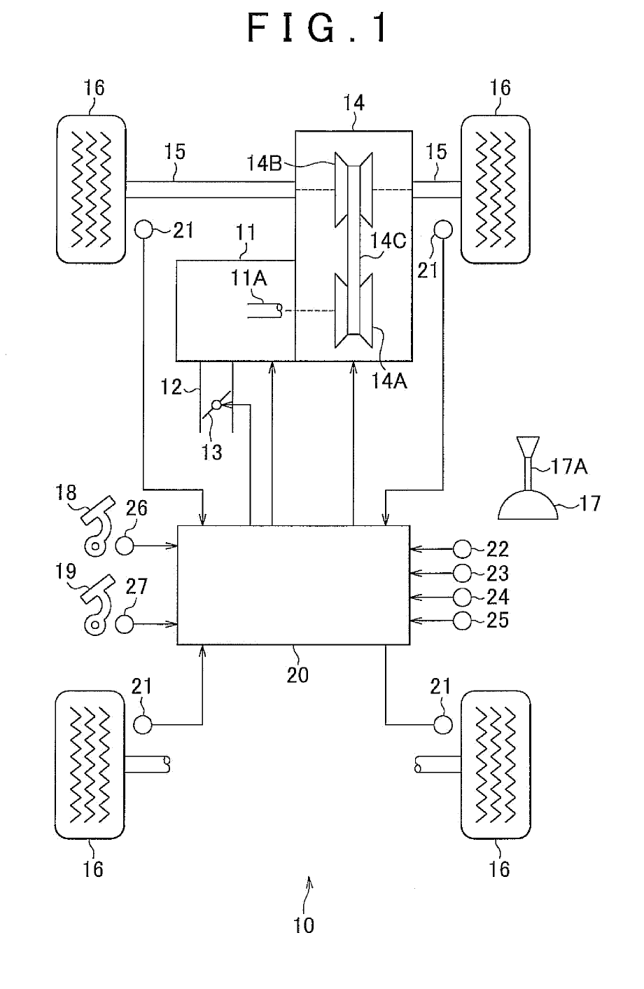

A vehicle control apparatus according to the first embodiment of the invention will be described hereinafter. As shown in FIG. 1, a vehicle 10 is mounted with an internal combustion engine 11 as a drive source. A throttle valve 13 is fitted to an intake passage 12 of this internal combustion engine 11. The vehicle 10 is configured such that the output torque (more specifically, the intake air amount) of the internal combustion engine 11 is adjusted through the control of the opening degree of the throttle valve 13. An output shaft 11A of the internal combustion engine 11 is coupled to an axle 15 and wheels 16 via a continuously variable transmission 14. As the continuously variable transmission 14, a belt-type continuously variable transmission is adopted. The belt-type continuously variable transmission 14 includes a primary pulley 14A coupled to the output shaft 11A of the internal combustion engine 11, a secondary pulley 14B coupled to the axle 15, and a belt 14C wound around those pulleys 14A and 14B. The vehicle 10 is configured such that the speed ratio is steplessly changed through operation control of the continuously variable transmission 14.

The vehicle 10 is mounted with a shift device 17 for changing the operation mode of the continuously variable transmission 14. In performing a driving operation of the vehicle 10, the aforementioned shift device 17 (more specifically, a shift lever 17A) is operated to one of a drive (forward) position (a D position), a reverse position (an R position), a park position (a P position), and a neutral position (an N position) through an operation by a passenger. More specifically, the D position is selected when causing the vehicle 10 to travel forward, the R position is selected when backing up the vehicle 10, the P position is selected when parking the vehicle 10, and the N position is selected when shutting off power transmission from the internal combustion engine 11 to the axle 15.

Various sensors for detecting a driving state of the vehicle 10 is fitted to the vehicle 10. More specifically, speed sensors 21 for detecting rotational speeds of the respective wheels 16 are fitted in the vicinity of the wheels 16. As the speed sensors 21, speed sensors that cannot detect rotational directions, namely, speed sensors that detect absolute values of rotational speeds of the wheels 16 are adopted. In this embodiment of the invention, a traveling speed (a vehicle speed SPD) of the vehicle 10 is obtained on the basis of output signals of the speed sensors 21. Incidentally, the vehicle speed SPD may be an average of the rotational speeds of the respective wheels 16 detected by the speed sensors 21, or a maximum value of the rotational speeds of the respective wheels 16, for example.

The shift device 17 is provided with switches 22, 23, 24, and 25 for detecting an operated position of the shift device 17. To be more specific, the shift device 17 is fitted with the D switch 22 for detecting that the shift device 17 has been operated to the D position, the R switch 23 for detecting that the shift device 17 has been operated to the R position, the P switch 24 for detecting that the shift device 17 has been operated to the P position, and the N switch 25 for detecting that the shift device 17 has been operated to the N position.

Further, the vehicle 10 is also fitted with an accelerator sensor 26 for detecting an operation amount AC of an accelerator pedal 18, a brake switch 27 for detecting the presence or absence of an operation of depressing a brake pedal 19, and the like.

The vehicle 10 is fitted with an electronic control unit 20 that is mainly composed of, for example, a microcomputer. The electronic control unit 20 acquires output signals of the various sensors, performs various calculations, and executes various kinds of control such as operation control of the internal combustion engine 11, operation control of the continuously variable transmission 14, and the like, on the basis of results of the calculations.

The operation control of the continuously variable transmission 14 is executed as follows. First of all, a control target value (a target rotational speed Tpr) for the rotational speed of a primary pulley 14A is set on the basis of a depression operation amount AC of the accelerator pedal 18, the vehicle speed SPD, and an operation state of the brake pedal 19. Then, the effective diameter of the primary pulley 14A is adjusted such that an actual rotational speed of the primary pulley 14A matches the target rotational speed Tpr. Thus, the speed ratio is automatically and steplessly changed in accordance with the driving state of the vehicle 10.

In this embodiment of the invention, as one of various kinds of control executed by the electronic control unit 20, vehicle speed limiting control of limiting the traveling speed of the vehicle 10 is executed when the vehicle 10 backs up. The vehicle speed limiting control is executed as follows.

First of all, it is determined whether or not the shift device 17 has been operated to back up the vehicle 10. That is, it is determined whether or not the driving operation to select the reverse travel of the vehicle 10 is performed. The determination is made on the basis of output signals of the respective switches 22, 23, 24, and 25, with which the shift device 17 is provided. In this embodiment of the invention, when the R switch 23 has been turned on and the D switch 22 has been turned off, it is determined that the shift device 17 has been operated to back up the vehicle 10. In this embodiment of the invention, the D switch 22, the R switch 23, and the electronic control unit 20 function as a detection unit.

When it is determined that the shift device 17 has not been operated to back up the vehicle 10, namely, when the operated position of the shift device 17 (hereinafter referred to as “a shift position”) is a position other than the R position, the processing of limiting the traveling speed of the vehicle 10 is not performed.

On the other hand, when it is determined that the shift device 17 has been operated to back up the vehicle 10, in other words, when it is determined that the shift position is the R position, the following processing is performed to limit the traveling speed of the vehicle 10.

In the vehicle speed limiting control, if the vehicle speed SPD is equal to or higher than a first first predetermined speed V1 (e.g., 20 km/h), feedback control of the output torque of the internal combustion engine 11 (more specifically, the opening degree of the throttle valve 13) is executed on the basis of the difference between the vehicle speed SPD and the first predetermined speed V1. If the vehicle speed SPD is lower than the first predetermined speed V1, the feedback control based on the aforementioned difference is not executed.

Through the execution of the vehicle speed limiting control, the vehicle speed SPD when the vehicle 10 backs up is limited to a speed equal to or lower than the first predetermined speed V1. In this embodiment of the invention, the aforementioned first predetermined speed V1 regarded as a first speed.

In the operation control for the continuously variable transmission 14 of this embodiment of the invention, regardless of whether the shift position is the D position or the R position, the speed ratio is automatically and steplessly changed in accordance with the driving state of the vehicle 10. Thus, the speed ratio in the reverse travel of the vehicle tends to be smaller than in a vehicle mounted with a multistage transmission having a shift speed for the reverse travel. As a result, the vehicle speed SPD tends to be high when the vehicle 10 backs up. For the above reason, there is a great demand for the aforementioned vehicle speed limiting control in the vehicle 10. In this embodiment of the invention, the vehicle speed limiting control is executed in the vehicle 10 mounted with the continuously variable transmission 14, so that the vehicle speed SPD when the vehicle 10 backs up is limited so as not to become excessively high.

In the vehicle speed limiting control, it is determined, on the basis of output signals of the D switch 22 and the R switch 23 that are fitted to the shift device 17, whether or not the shift device 17 has been operated to back up the vehicle 10. Thus, in the case where noise is superimposed on the output signals of the D switch 22 and the R switch 23 or the D switch 22 and the R switch 23 malfunction, it may be erroneously determined that the reverse travel has been selected, although a driving operation for selecting the reverse travel has not actually been performed. When such an erroneous determination is made and the vehicle speed SPD is limited through the execution of the vehicle speed limiting control while the vehicle 10 travels forward, the vehicle speed SPD may unnecessarily fall, or the degree of fall in the vehicle speed SPD may increases to cause a shock to the vehicle 10 when the vehicle speed SPD is high. As a result, a deterioration in drivability may be caused.

Thus, in this embodiment of the invention, in the case where the vehicle speed SPD is equal to or higher than a second predetermined speed V1 (e.g., 30 km/h) that is higher than the first predetermined speed VI, when an operation of the shift device 17 to the R position through the D switch 22 and the R switch 23 is detected, the execution of the aforementioned vehicle speed limiting control is prohibited.

In driving control of the vehicle 10, when the vehicle speed SPD is equal to or higher than the second predetermined speed V1, the possibility of the shift device 17 being operated to the R position through a driving operation is extremely low. Accordingly, it is highly likely that a determination that such an operation has been performed is an erroneous determination. In this embodiment of the invention, in the case where an operation of the shift device 17 to the R position is detected when the vehicle speed SPD is equal to or higher than the second predetermined speed V1, a determination that the shift device 17 has been operated to back up the vehicle 10 is considered to be erroneous, and the execution of the vehicle speed limiting control is prohibited.

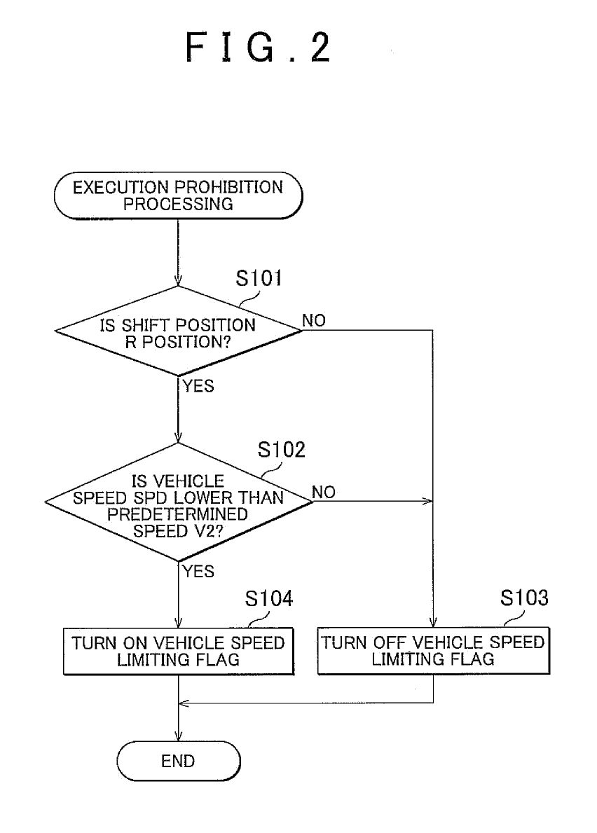

The procedure of performing a processing of prohibiting the execution of the vehicle speed limiting control (an execution prohibition processing) will be described in detail with reference to a flowchart shown in FIG. 2. A series of processes shown in the flowchart are carried out by the electronic control unit 20, as an interrupt processing in a predetermined cycle.

As shown in FIG. 2, first of all in this processing, it is determined whether a first condition and a second condition 2 shown below are both satisfied.

[First Condition] It is determined that the shift position is the R position (step S101).

[Second Condition] The vehicle speed SPD is lower than the second predetermined speed V1 (step S102).

As the aforementioned second predetermined speed V1, a certain value that satisfies both the following requirements is obtained in advance and stored into the electronic control unit 20.

[First Requirement] The second predetermined speed V1 is an upper-limit speed (or a speed slightly lower than the upper-limit speed) in a vehicle speed range in which a shock to the vehicle 10, occurring when the execution of the vehicle speed limiting control is started, may not cause the deterioration in drivability.

[Second Requirement] In the case where the vehicle speed SPD overshoots the first predetermined speed V1 when the execution of the vehicle speed limiting control is started in response to the vehicle speed SPD having become equal to or higher than the first predetermined speed V1 in backing up the vehicle 10, the overshooting vehicle speed SPD do not exceed the second predetermined speed V1.

Then, when the first condition is not satisfied (step S101: NO), it is determined that there is no need to execute the vehicle speed limiting control because the shift position is not the R position, and therefore, a vehicle speed limiting flag is turned off (step S103). In this embodiment of the invention, when the vehicle speed limiting flag is turned off, the vehicle speed limiting control is not executed.

Thereafter, when both the first condition and the second condition are both satisfied (“YES” in both step S101 and step S102) through the repetitious performance of this processing, the vehicle speed limiting flag is turned on (step S104). In this embodiment of the invention, when the vehicle speed limiting flag is turned on, the vehicle speed limiting control is executed.

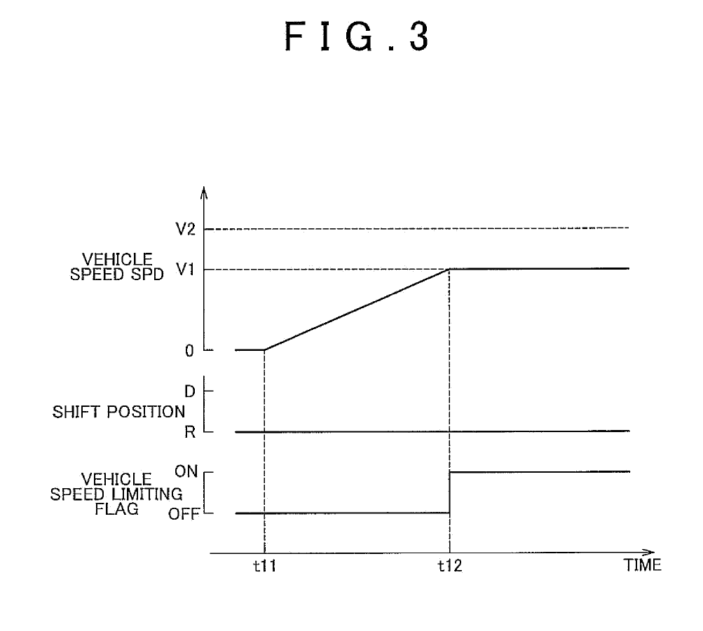

A mode of limiting the vehicle speed SPD in this case (a first example) will be described with reference to a timing chart shown in FIG. 3. As shown in FIG. 3, when the shift position becomes the R position, the back-up of the vehicle 10 is started (at a time t11). Thereafter, when the vehicle speed SPD gradually increases to reach the first predetermined speed V1 (at a time t12), the vehicle speed limiting flag is turned on to start the execution of the vehicle speed limiting control. Thus, the vehicle speed SPD is limited to a speed equal to or lower than the first predetermined speed V1, and hence is restrained from excessively increasing. In this case, the vehicle speed SPD does not increase to become equal to or higher than the second predetermined speed V1.

On the other hand, when the first condition is satisfied (step S101: YES) and the second condition is not satisfied (step S102: NO), the vehicle speed limiting flag is turned off (step S103), and the vehicle speed limiting control is not executed.

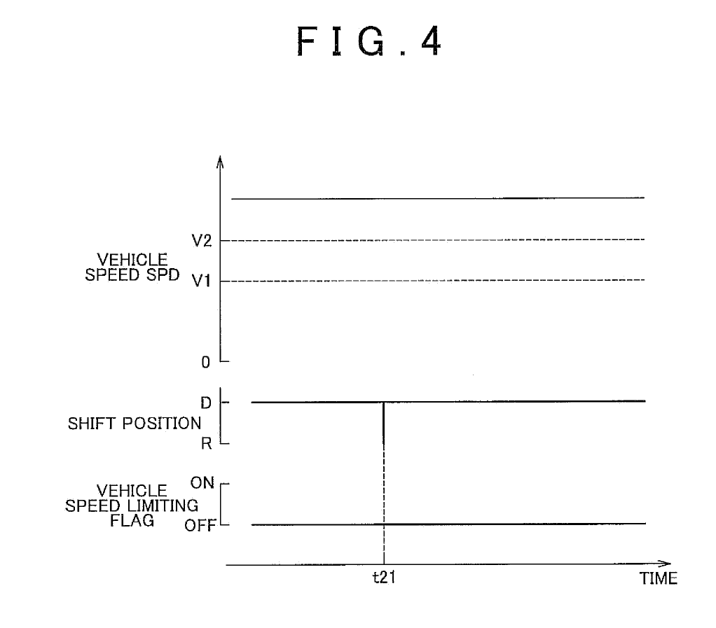

A mode of limiting the vehicle speed SPD in this case (a second example) will be described with reference to a timing chart shown in FIG. 4. In the second example shown in FIG. 4, prior to a time t21, the shift position is the D position and the vehicle 10 travels forward. At this time, the vehicle speed SPD is higher than the second predetermined speed V1. In this processing, even when it is erroneously determined that the shift position has become the R position (at the time t21) due to the superimposition of noise on output signals of the R switch 23 and the D switch 22, a false operation of the electronic control unit 20, or the like in this state, the vehicle speed limiting flag is not turned on. That is, the vehicle speed limiting control is not executed, and therefore, the vehicle speed SPD is restrained from unnecessarily falling. Thus, the vehicle speed SPD does not abruptly fall, and a shock resulting from deceleration of the vehicle 10 does not occur.

As described hitherto, according to this processing, the vehicle speed limiting control of limiting the vehicle speed SPD is executed in backing up the vehicle 10, but an unnecessary fall in the vehicle speed SPD or the occurrence of a shock can be restrained in the case where it is erroneously detected that the reverse travel of the vehicle 10 has been selected while the vehicle 10 travels forward. Consequently, the drivability can be restrained from deteriorating.

After the first condition and the second condition are both satisfied (“YES” in both step S101 and step S102) and the execution of the vehicle speed limiting control is prohibited, when the vehicle speed SPD falls to become lower than the second predetermined speed V1 (step S102: YES), the vehicle speed limiting flag is turned on (step S104). That is, in this case, the prohibition of the execution of the vehicle speed limiting control is canceled, and the execution of the vehicle speed limiting control is started.

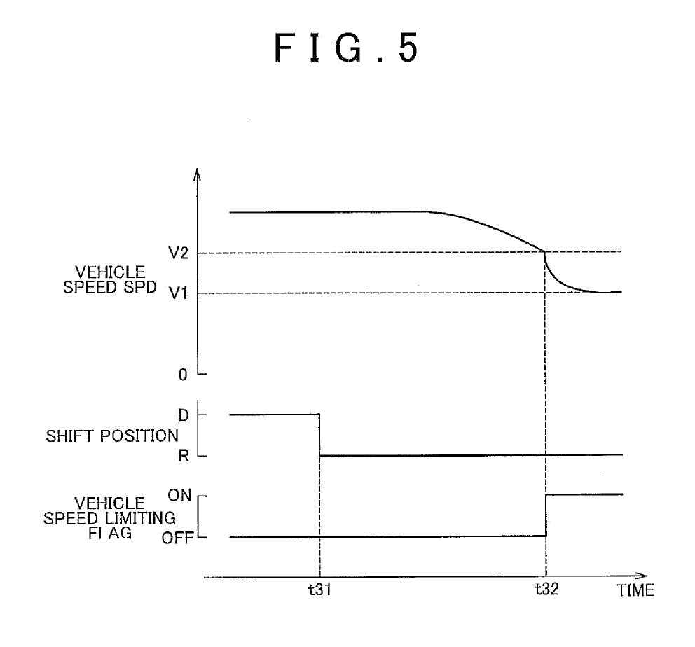

A mode of limiting the vehicle speed SPD in this case (a third example) will be described with reference to a timing chart shown in FIG. 5. In the third example shown in FIG. 5, prior to a time t31, the shift position is the D position and the vehicle 10 travels forward. At this time, the vehicle speed SPD is higher than the second predetermined speed V1. Then, when it is erroneously determined at the time t31 that the shift position has become the R position, the execution of the vehicle speed limiting control is prohibited through an execution prohibition processing. Then, when the vehicle speed SPD becomes lower than the second predetermined speed V1 (at a time t32), the prohibition of the execution of the vehicle speed limiting control is canceled to start the execution of the vehicle speed limiting control. As described hitherto, in this embodiment of the invention, the prohibition of the execution of the vehicle speed limiting control is canceled on the condition that the vehicle speed SPD have fallen to become lower than the second predetermined speed V1, in other words, on the condition that the vehicle speed SPD have become low enough not to cause a great shock even in the case where the vehicle speed limiting control is executed. Accordingly, a shock can be restrained from occurring due to the cancellation of the prohibition of the execution of the vehicle speed limiting control.

As described above, according to this embodiment of the invention, the following effects are obtained.

(1) When the vehicle speed SPD is equal to or higher than the second predetermined speed V1 and an operation of the shift device 17 to the R position is detected on the basis of output signals of the D switch 22 and the R switch 23, the execution of the vehicle speed limiting control is prohibited. Thus, in an apparatus in which the vehicle speed limiting control of limiting the vehicle speed SPD when the vehicle 10 backs up is executed, the drivability can be restrained from deteriorating in the case where it is erroneously detected that the reverse travel of the vehicle 10 has been selected while the vehicle 10 travels forward.

(2) On the condition that the vehicle speed SPD have become low enough not to cause a great shock even in the case where the vehicle speed limiting control is executed, the prohibition of the execution of the vehicle speed limiting control can be canceled. Accordingly, a shock can be restrained from occurring as a result of the cancellation of the prohibition of the execution of the vehicle speed limiting control.

(3) In the vehicle 10 which is mounted with the continuously variable transmission 14, whose vehicle speed SPD therefore tends to be high when the vehicle 10 backs up, and in which there is a great demand for the vehicle speed limiting control, the vehicle speed limiting control is executed. Then, the drivability can be suitably restrained from deteriorating in the case where it is erroneously detected that the reverse travel of the vehicle 10 has been selected while the vehicle 10 travels forward during the execution of the vehicle speed limiting control.

### Second Embodiment

A vehicle control apparatus according to the second embodiment of the invention will be described hereinafter focusing mainly on differences from the first embodiment of the invention. In the following, components identical to those of the first embodiment of the invention will be denoted by the same reference symbols respectively, and detailed description thereof will be omitted.

The vehicle control apparatus according to the second embodiment of the invention is different from the vehicle control apparatus according to the first embodiment of the invention in the mode of performing the execution prohibition processing. The execution prohibition processing according to the second embodiment of the invention will be concretely described hereinafter.

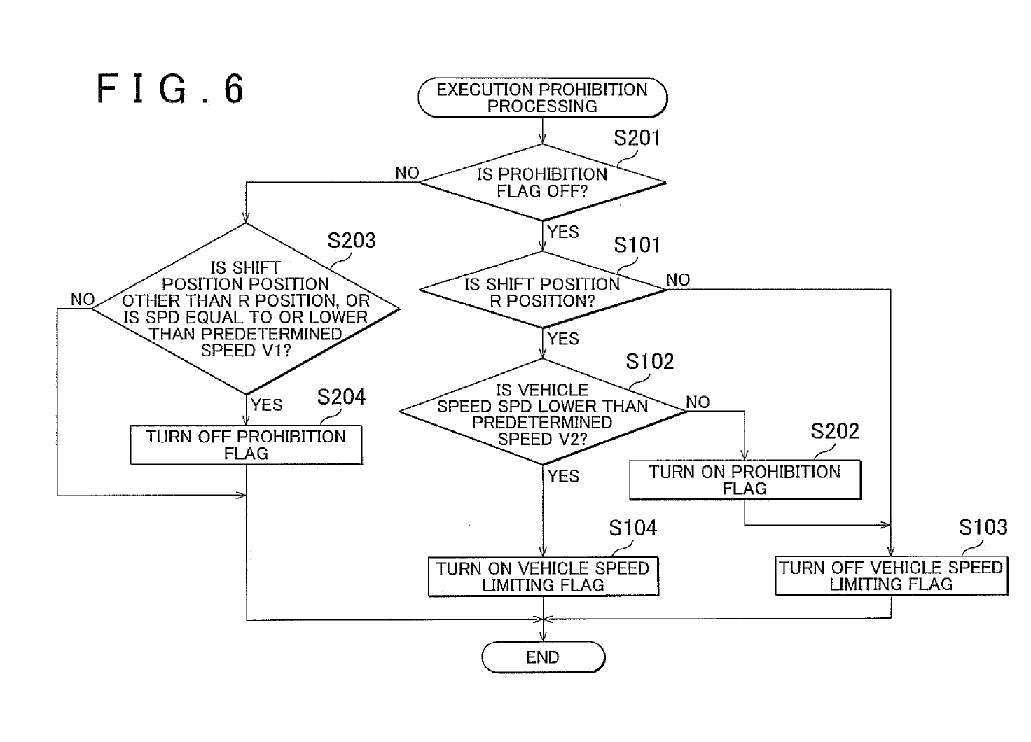

FIG. 6 is a flowchart showing a concrete procedure of performing the execution prohibition processing. A series of processes shown in the flowchart are carried out by the electronic control unit 20, as an interrupt processing in a predetermined cycle.

As shown in FIG. 6, in this processing, on the condition that a prohibition flag have been turned off (step S201: YES), a determination based on the first condition (step S101) and a determination based on the second condition (step S102) are made. The prohibition flag is turned off in an initial state.

When the first condition is satisfied (step S101: YES) and the second condition is not satisfied (step S102: NO), the prohibition flag is turned on (step S202), and the vehicle speed limiting flag is turned off (step S103) to prohibit the execution of the vehicle speed limiting control. As described hitherto, in this processing, the prohibition flag is turned on at a timing when the execution of the vehicle speed limiting control is prohibited.

After the prohibition flag is turned on (step S201: NO) as described above, the prohibition flag is held on unless one of a third condition and a fourth condition shown below is satisfied (step S203: NO) (the process of step S204 is skipped). Therefore, the processes from step S101 to step S104 are not carried out, and the vehicle speed limiting flag is held off to continue to prohibit the execution of the vehicle speed limiting control.

[Third Condition] It is determined that the shift position is a position other than the R position.

[Fourth condition] The vehicle speed SPD is equal to or lower than the first predetermined speed V1.

Thereafter, when one of the third condition and the fourth condition is satisfied (step S203: YES) through the repetitive performance of this processing, the prohibition flag is turned off (step S204). Thus, after the prohibition flag is turned off (step S201: YES), the processes of step S101 to step S104 are carried out. That is, the prohibition of the execution of the vehicle speed limiting control is canceled.

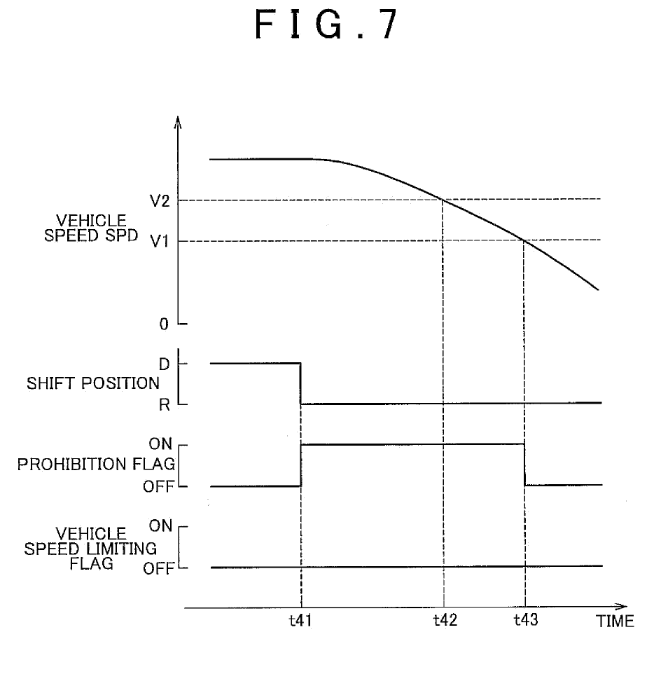

An operation achieved by performing the aforementioned execution prohibition processing will be described hereinafter with reference to a timing chart shown in FIG. 7. In a fourth example shown in FIG. 7, prior to a time t41, the shift position is the D position and the vehicle 10 travels forward. At this time, the vehicle speed SPD is higher than the second predetermined speed V1. Then, when it is erroneously determined at the time t41 that the shift position has become the R position, the execution of the vehicle speed limiting control is prohibited through the execution prohibition processing. In addition, the prohibition flag is turned on at this time. Thereafter, even when the vehicle speed SPD falls to become lower than the second predetermined speed V1 (at a time t42), the prohibition of the execution of the vehicle speed limiting control is continued because the prohibition flag has been turned on.

Thereafter, when the vehicle speed SPD further falls to become equal to or lower than the first predetermined speed VI (at a time t43), the prohibition flag is turned off to cancel the prohibition of the execution of the vehicle speed limiting control. As described hitherto, in this embodiment of the invention, the prohibition of the execution of the vehicle speed limiting control is cancelled on the condition that the vehicle speed SPD have fallen to become equal to or lower than the first predetermined speed V1.

In the driving control of the vehicle 10, the possibility of a driving operation of operating the shift device 17 to the R position being performed when the vehicle speed SPD is equal to or higher than the second predetermined speed V1 is extremely low. Therefore, it is highly likely that a determination that such an operation has been performed is an erroneous determination.

On the other hand, according to this embodiment of the invention, when the vehicle speed SPD has become lower than the second predetermined speed V1 after the execution of the vehicle speed limiting control is prohibited, the credibility of a determination itself that the shift position is the R position is considered to be low, and the prohibition of the execution of the vehicle speed limiting control is continued over a period to a time when the vehicle speed SPD further falls to become equal to or lower than the first predetermined speed V1. Thus, when it is erroneously determined that the shift position is the R position, the vehicle speed limiting control is reliably restrained from being executed on the basis of the erroneous determination.

Further, in this embodiment of the invention, in the case where it is determined that the shift position becomes a position other than the R position after the execution of the vehicle speed limiting control is prohibited as well, the prohibition flag is turned off, and the prohibition of the execution Of the vehicle speed limiting cool is cancelled. Thus, on the condition that a situation where there is no need to execute the vehicle speed limiting control arise, the prohibition of the execution of the vehicle speed limiting control can be cancelled.

As described above, according to this embodiment of the invention, in addition to the effects described in the foregoing remarks (1) and (3), effects described in the following remarks (4) and (5) are obtained.

(4) The prohibition of the execution of the vehicle speed limiting control is canceled on the condition that the vehicle speed SPD have fallen to become equal to or lower than the first predetermined speed V1. Therefore, in the case where it is erroneously determined that the shift position is the R position, the vehicle speed limiting control can be reliably restrained from being executed on the basis of the erroneous determination.

(5) The prohibition of the execution of the vehicle speed limiting control can be canceled on the condition that a situation where there is no need to execute the vehicle speed limiting control arise.

### Other Embodiments

It should be noted that each of the foregoing embodiments of the invention may be modified and implemented as follows.

In accordance with the prohibition of the execution of the vehicle speed limiting control, a warning lamp fitted in a vehicle interior may be lit up, or a history of the prohibition of the execution may be stored into a memory of the electronic control unit 20. The mode of executing the vehicle speed limiting control is not limited to the execution of the feedback control of the opening degree of the throttle valve 13. The mode of executing the vehicle speed limiting control may be arbitrarily modified. For example, the vehicle speed limiting control may be executed by executing the feedback control of the fuel injection amount, temporarily stopping fuel injection, or the like. That is, any mode in which the traveling speed of the vehicle 10 is limited to a speed equal to or lower than a predetermined speed during the back-up of the vehicle 10 is acceptable.

Instead of detecting the vehicle speed SPD on the basis of the output signals of the respective speed sensors 21, it is also applicable to provide a axle speed sensor that detects a rotational speed of the axle 15 and detect the vehicle speed SPD on the basis of an output signal of the axle speed sensor, or to provide a transmission output shaft speed sensor that detects a rotational speed of the output shaft of the continuously variable transmission 14 and detect the vehicle speed SPD on the basis of an output signal of the transmission output shaft speed sensor.

It is also applicable to provide a operation mode sensor (or a switch) for detecting an operation mode of the continuously variable transmission 14, and detect an operated position of the shift device 17 on the basis of an output signal of the operation mode sensor.

The conditions for prohibiting the execution of the vehicle speed limiting control are not limited to the first condition and the second condition, but may be arbitrarily, modified. For example, it is possible to prohibit the execution of the vehicle speed limiting control on the condition that a fifth condition shown below is satisfied during the last performance of a processing that is performed on a predetermined cycle and a sixth condition shown below is satisfied during the current performance of the processing.

[Fifth Condition] It is determined that the shift position is in the D position and the vehicle speed SPD is equal to or higher than the second predetermined speed V1.

[Sixth Condition] It is determined that the shift position is in the R position.

That is, it is applicable to adopt any condition that prohibits the execution of the vehicle speed limiting control when it is detected that the driving operation of selecting the reverse travel of the vehicle 10 has been performed in a situation where the vehicle speed SPD is equal to or higher than the second predetermined speed V1.

The vehicle control apparatus according to each of the foregoing embodiments of the invention may be applied not only to the vehicle 10 mounted with the belt-type continuously variable transmission 14 but also to a vehicle mounted with a toroidal-type continuously variable transmission.

The invention may be applied to a vehicle mounted with a multi-stage automatic transmission as well as a vehicle mounted with a continuously variable transmission. Further, the invention may be applied not only to a vehicle mounted with an automatic transmission but also to a vehicle mounted with a manual transmission. That is, the invention may be applied to any apparatus that executes the vehicle speed limiting control of limiting the traveling speed of a vehicle to a speed equal to or lower than a predetermined speed when the reverse travel of the vehicle is selected.

What is claimed is:

1. A vehicle control apparatus comprising:
a detection unit that detects whether or not a reverse driving operation to select a reverse travel of a vehicle has been performed, wherein the vehicle backs up in the reverse travel; and
a control unit that executes vehicle speed limiting control of limiting a traveling speed of the vehicle to a speed equal to or lower than a first speed when the vehicle backs up, and prohibits execution of the vehicle speed limiting control when the traveling speed of the vehicle is equal to or higher than a second speed that is higher than the first speed and when the detection unit detects that the reverse driving operation has been performed.

2. The vehicle control apparatus according to claim 1, wherein the control unit cancels prohibition of the execution of the vehicle speed limiting control on a condition that the traveling speed have fallen to become lower than the second speed.

3. The vehicle control apparatus according to claim 1, wherein the control unit cancels prohibition of the execution of the vehicle speed limiting control on a condition that the traveling speed have fallen to become equal to or lower than the first speed.

4. The vehicle control apparatus according to claim 1, wherein the control unit cancels prohibition of the execution of the vehicle speed limiting control on a condition that the detection unit detect that the reverse driving operation has not been performed.

5. The vehicle control apparatus according to claim 1, wherein the vehicle is mounted with a continuously variable transmission that continuously changes a speed ratio.

6. The vehicle control apparatus according to claim 1, wherein:
the vehicle is mounted with a transmission, and a shift device that changes an operation mode of the transmission; and
the detection unit detects that the reverse driving operation has been performed when the shift device has been operated to a reverse position.

7. A vehicle control method comprising:
detecting whether or not a reverse driving operation to select a reverse travel of a vehicle has been performed, wherein the vehicle backs up in the reverse travel;
executing vehicle speed limiting control of limiting a traveling speed of the vehicle to a speed equal to or lower than a first speed when the vehicle backs up; and
prohibiting execution of the vehicle speed limiting control when the traveling speed of the vehicle is equal to or higher than a second speed that is higher than the first speed and when it is detected that the reverse driving operation has been performed.
